(19) United States
(12) Patent Application Publication
(10) Pub. No.: US 2026/0296138 A1
(43) Pub. Date: Oct. 1, 2026

(54) HEAT PUMP SYSTEM FOR VEHICLE

(71) Applicant: Hanon Systems, Daejeon (KR)

(72) Inventors: Jun Min LEE, Daejeon (KR); Ibarra Fernandez MARKEL, Daejeon (KR); Sung Jin KIM, Daejeon (KR); Young In KIM, Daejeon (KR); Yong Sik KIM, Daejeon (KR); Hyeon Gyu KIM, Daejeon (KR)

(73) Assignee: Hanon Systems, Daejeon (KR)

(21) Appl. No.: 19/472,071

(22) PCT Filed: May 16, 2024
(86) PCT No.: PCT/KR2024/006655

§ 371 Date: Oct. 2, 2025

(30) Foreign Application Priority Data
May 22, 2023 (KR) 10-2023-0065566
May 14, 2024 (KR) 10-2024-0063307

(51) Int. Cl. B60H 1/00; B60H 1/32

(52) U.S. Cl. CPC B60H 1/00907; B60H 1/00278; B60H 1/3207; B60H 1/3228

(57) ABSTRACT

Disclosed is a heat pump system for a vehicle, capable of removing an accumulator, preventing heat pickup to an indoor heat exchanger even if a temperature door is removed, and changing a refrigerant flow in an outdoor condenser according to an air conditioning mode through a simple structure. The heat pump system for a vehicle includes a refrigerant line for cooling or heating the interior of the vehicle by using a refrigerant discharged from a compressor. An outdoor condenser for condensing the refrigerant by exchanging heat between the refrigerant and outdoor air is provided in the refrigerant line. A refrigerant inlet and a refrigerant outlet of the outdoor condenser can be switched by switching the refrigerant flow direction of the refrigerant line.

### TECHNICAL FIELD

The present invention relates to a heat pump system for a vehicle, and more particularly, to a heat pump system for a vehicle that is installed in an electric vehicle or the like to perform heating through an indoor heat exchanger and perform cooling through an evaporator.

### Background Art

In general, an air conditioner for a vehicle includes a cooling system for cooling the interior of the vehicle, and a heating system for heating the interior of the vehicle. The cooling system, at an indoor heat exchanger side of a refrigerant cycle, converts air passing the outside of an indoor heat exchanger into cold air by exchanging heat between the air and a refrigerant flowing inside an evaporator to cool the interior of the vehicle. Moreover, the heating system, at a heater core side of a cooling water cycle, converts the air passing the outside of the heater core into warm air by exchanging heat between the air and cooling water flowing inside the heater core to heat the interior of the vehicle.

Meanwhile, a heat pump system capable of selectively performing cooling and heating by switching a refrigerant flow direction using one refrigerant cycle, which is different from the above-described air conditioner for the vehicle, is being applied. The heat pump system is installed in an electric vehicle or the like that does not use an engine and performs cooling and heating of the interior of the vehicle using evaporation heat and condensation heat of the refrigerant.

Referring to FIG. 1, a conventional heat pump system for a vehicle includes a refrigerant line 6, an electrical component cooling water line 21, and a battery cooling water line 31. The refrigerant line 6 includes, in sequence, a compressor 1, an indoor heat exchanger 2, a first expansion valve 3, a water-cooled condenser 4, a receiver dryer 5, an outdoor condenser 7, a second expansion valve 8, an evaporator 9, and an accumulator 10.

An evaporator bypass line 11 that bypasses the evaporator 9 branches from the refrigerant line 6. The evaporator bypass line 11 includes a third expansion valve 12 and a chiller 13. The chiller 13 exchanges heat between the refrigerant and cooling water in a battery cooling water line 31 to cool a battery 30. The refrigerant that has passed through the outdoor condenser 7 circulates to the compressor 1 after passing through the second expansion valve 8 and the evaporator 9 or circulates to the compressor 1 after bypassing the evaporator 9 and passing through the third expansion valve 12 and the chiller 13.

The compressor 1 discharges refrigerant of high-temperature and high-pressure to the indoor heat exchanger 2. The indoor heat exchanger 2 is provided in an air conditioning case 15 and exchanges heat with the air passing therethrough to heat the air. The evaporator 9 and the indoor i heat exchanger 2 are sequentially provided in an air passage in the air conditioning case 15. An electric heater 12 such as a PTC is provided downstream of the indoor heat exchanger 2 in an air flow direction. A temperature door 14 is provided between the evaporator 9 and the indoor heat exchanger 2 to adjust the air temperature.

The first expansion valve 3 is an electronic expansion valve (EXV) that controls the flow rate of the refrigerant and expands the refrigerant, and selectively expands the refrigerant or allows the refrigerant to pass through. The second expansion valve 8 is provided at the front end of the evaporator 9 and is a thermal expansion valve (TXV) that expands the refrigerant. The third expansion valve 12 is provided at the front end of the chiller 13 and is an electronic expansion valve (EXV) that controls the flow rate of the refrigerant and expands the refrigerant, and selectively expands the refrigerant or allows the refrigerant to pass through.

The water-cooled condenser 4 exchanges heat between the refrigerant in the refrigerant line 6 and the cooling water in the electrical component cooling water line 21 or the battery cooling water line 31. The receiver dryer 5 separates and stores gaseous refrigerant and liquid refrigerant. The outdoor condenser 7 is installed at the front of the vehicle and exchanges heat between the refrigerant and outdoor air. The evaporator 9 is provided in the air conditioning case 15 and cools the air by exchanging heat with the air passing therethrough. The accumulator 10 is provided upstream of the compressor 1 and separates gaseous refrigerant and liquid refrigerant.

The electrical component cooling water line 21 includes an electrical component 20 including a power electric (PE) module, an electrical component radiator 23, a reservoir tank 24, and a water pump 25. The cooling water passing through the electrical component 20 passes through the water-cooled condenser 4, the electrical component radiator 23, the reservoir tank 24, and the water pump 25, and then, circulates to the electrical component 20. A direction switching valve 22 is provided in the electrical component cooling water line 21 to send the cooling water that has passed through the water-cooled condenser 4 to the electrical component radiator 23 or to allow the cooling water to bypass.

The battery cooling water line 31 includes a battery 30, a heating heater 32, a battery radiator 35, a reservoir tank 34, and a water pump 33. The cooling water passing through the battery 30 is cooled by exchanging heat with the refrigerant in the chiller 13 or is cooled by outdoor air after being sent to the water-cooled condenser 4 and the battery radiator 35. A direction switching valve 36 is provided in the battery cooling water line 31 to send the cooling water that has passed through the chiller 13 to the battery radiator 35 or to allow the cooling water to bypass.

In a cooling mode, the conventional heat pump system for a vehicle controls superheat by the thermal expansion valve (TXV) mechanism of the second expansion valve 8, so uses the receiver dryer 5 as a refrigerant storage unit instead of the accumulator 10. In a heating mode, the conventional heat pump system for a vehicle causes condensation of the refrigerant in the indoor heat exchanger 2. In this instance, the capacity of the indoor heat exchanger 2 is small, so the amount of refrigerant used is less than that in the cooling mode.

When the amount of refrigerant in the system is charged based on the cooling mode, a large amount of excess refrigerant exists in the heating mode. To store the excess refrigerant, a large-sized accumulator 10 must be used. As a result, the conventional heat pump system for a vehicle must use the receiver dryer 5 and the accumulator 10 simultaneously.

Furthermore, in the conventional heat pump system for a vehicle, refrigerant always passes through the indoor heat exchanger 2 even in the cooling mode. Therefore, even when indoor heating is not required, refrigerant passes through the indoor heat exchanger 2, causing heat loss due to heat pickup. Additionally, since the temperature door 14 must block heat exchange between the air and the indoor heat exchanger 2, it is difficult to consider a design in which the temperature door 14 is removed, and the heat pump system occupies a large space, resulting in an increase in the size of an air conditioner.

Moreover, in the conventional heat pump system for a vehicle, since the state of the refrigerant is changed from gas to liquid in the cooling mode, the refrigerant flows downward in the outdoor condenser 7. In addition, since the refrigerant is changed from liquid to gas in the heating mode, system performance can be improved by allowing the refrigerant to flow upward, thus improving the performance of the conventional heat pump system. However, the conventional heat pump system for a vehicle has a limitation since the refrigerant flows only in one direction in the outdoor condenser 7. To realize a bidirectional flow of the refrigerant, the refrigerant line becomes complex and the number of additional components such as valves increases.

### Disclosure

### Technical Problem

Accordingly, the present invention has been made in view of the above-mentioned problems occurring in the related art, and it is an objective of the present invention to provide a heat pump system for a vehicle, which is capable of removing an accumulator, preventing heat pickup to an indoor heat exchanger even if a temperature door is removed, and changing a refrigerant flow in an outdoor condenser according to an air conditioning mode through a simple structure.

### Technical Solution

To accomplish the above-mentioned objects, according to the present invention, there is provided a heat pump system for a vehicle comprising a refrigerant line for cooling or heating an interior of the vehicle by using a refrigerant discharged from a compressor, wherein the refrigerant line comprises an outdoor condenser configured to condense the refrigerant by exchanging heat between the refrigerant and outdoor air, and a refrigerant inlet and a refrigerant outlet of the outdoor condenser are switchable by switching a refrigerant flow direction of the refrigerant line.

In a cooling mode, the refrigerant flows into an upper portion of the outdoor condenser and is discharged downward, and in a heating mode, the refrigerant flows into a lower portion of the outdoor condenser and is discharged upward.

The refrigerant line comprises an indoor heat exchanger arranged in an air conditioning case to exchange heat between the refrigerant discharged from the compressor and air, and the refrigerant discharged from the compressor selectively flows to the indoor heat exchanger or the outdoor condenser.

The refrigerant discharged from the compressor is configured to pass through or bypass the indoor heat exchanger.

The heat pump system for a vehicle further includes: a first direction switching valve arranged downstream of the compressor in the refrigerant flow direction and selectively directing the refrigerant discharged from the compressor to the indoor heat exchanger or the outdoor condenser; and a second direction switching valve directing the refrigerant having passed through the first direction switching valve to the outdoor condenser or directing the refrigerant having passed through the outdoor condenser to the compressor.

The heat pump system for a vehicle further includes: a receiver dryer configured to separate and store gaseous refrigerant and liquid refrigerant, wherein the refrigerant flow is controlled such that in a cooling mode the receiver dryer is located downstream of the outdoor condenser in the refrigerant flow direction and in a heating mode the receiver dryer is located downstream of the indoor heat exchanger in the refrigerant flow direction.

The refrigerant line includes: an evaporator arranged downstream of the receiver dryer in the refrigerant flow direction and located in the air conditioning case to exchange heat between the refrigerant and air; a first expansion valve arranged between the receiver dryer and the outdoor condenser to expand the refrigerant; a second expansion valve arranged between the receiver dryer and the evaporator to expand the refrigerant; and a third expansion valve arranged between the indoor heat exchanger and the receiver dryer to expand the refrigerant.

The heat pump system for a vehicle further includes: a bypass line arranged downstream of the receiver dryer in the refrigerant flow direction and configured to circulate the refrigerant to the compressor by bypassing the evaporator; a fourth expansion valve to expand the refrigerant and a chiller to exchange heat between the refrigerant and cooling water circulating through an electrical component or a battery are provided in the bypass line.

The first to fourth expansion valves are electronic expansion valves (EXVs) configured to control a flow rate of the refrigerant and expand the refrigerant.

The first direction switching valve is a three-way valve connected to the compressor, the indoor heat exchanger, and the second direction switching valve, and the second direction switching valve is a three-way valve connected to the first direction switching valve, the compressor, and the outdoor condenser.

In another aspect of the present invention, provided is a heat pump system for a vehicle including a refrigerant line for cooling or heating an interior of the vehicle by using a refrigerant discharged from a compressor, wherein the refrigerant line includes: an outdoor condenser configured to condense the refrigerant by exchanging heat between the refrigerant and outdoor air; and an indoor heat exchanger arranged in an air conditioning case to exchange heat between the refrigerant discharged from the compressor and air, wherein the refrigerant discharged from the compressor selectively flows to the indoor heat exchanger or the outdoor condenser.

In another aspect of the present invention, provided is a heat pump system for a vehicle including a refrigerant line for cooling or heating an interior of the vehicle by using a refrigerant discharged from a compressor, wherein the refrigerant line includes: an outdoor condenser configured to condense the refrigerant by exchanging heat between the refrigerant and outdoor air; an indoor heat exchanger arranged in an air conditioning case to exchange heat between the refrigerant discharged from the compressor and air; and a receiver dryer configured to separate and store gaseous refrigerant and liquid refrigerant, wherein the refrigerant flow is controlled such that in a cooling mode the receiver dryer is located downstream of the outdoor condenser in the refrigerant flow direction and in a heating mode the receiver dryer is located downstream of the indoor heat exchanger in the refrigerant flow direction.

The refrigerant line includes an evaporator arranged downstream of the receiver dryer in the refrigerant flow direction and located in the air conditioning case to exchange heat between the refrigerant and air, and the liquid refrigerant among the gaseous refrigerant and the liquid refrigerant Separated in the receiver dryer is discharged and flows toward the outdoor condenser or the evaporator.

The receiver dryer has three ports, wherein a first port connected to the indoor heat exchanger allows refrigerant to flow only into the receiver dryer, and a second port connected to the evaporator allows refrigerant to flow only out of the receiver dryer.

A third port connected to the outdoor condenser allows refrigerant to flow into or out of the receiver dryer.

In a dehumidification mode, a portion of the refrigerant discharged from the compressor flows to the indoor heat exchanger to heat air directed into the interior, passes through the third expansion valve, and flows into the receiver dryer, another portion of the refrigerant flows to the second direction switching valve, passes through the outdoor condenser and the first expansion valve sequentially, and flows into the receiver dryer, the refrigerant in the receiver dryer flows to the second expansion valve, is expanded, exchanges heat with air in the evaporator, and circulates to the compressor, and the flow rate of the refrigerant flowing into the indoor heat exchanger is controlled through the first and third expansion valves to achieve a target discharge temperature.

In a dehumidification and battery cooling mode, a portion of the refrigerant discharged from the compressor flows to the indoor heat exchanger to heat air directed into the interior, passes through the third expansion valve, and flows into the receiver dryer, another portion of the refrigerant flows to the second direction switching valve, passes through the outdoor condenser and the first expansion valve sequentially, and flows into the receiver dryer, a portion of the refrigerant in the receiver dryer flows to the second expansion valve, is expanded, exchanges heat with air in the evaporator, and circulates to the compressor, and another portion is expanded through the fourth expansion valve, flows to the chiller, exchanges heat with the cooling water in a cooling water line, and circulates to the compressor, and the flow rate of the refrigerant flowing into the indoor heat exchanger is controlled through the first and third expansion valves to achieve a target discharge temperature.

In a temperature control mode during cooling, a portion of the refrigerant discharged from the compressor flows to the indoor heat exchanger to heat air directed into the interior, passes through the third expansion valve, and flows into the receiver dryer, another portion of the refrigerant flows to the second direction switching valve, passes through the outdoor condenser and the first expansion valve sequentially, and flows into the receiver dryer, the refrigerant in the receiver dryer flows to the second expansion valve, is expanded, exchanges heat with air in the evaporator, and circulates to the compressor, and the flow rate of the refrigerant flowing into the indoor heat exchanger is controlled through the first and third expansion valves to achieve a target discharge temperature.

In a temperature control mode during cooling and battery cooling, a portion of the refrigerant discharged from the compressor flows to the indoor heat exchanger to heat air directed into the interior, passes through the third expansion valve, and flows into the receiver dryer, another portion of the refrigerant flows to the second direction switching valve, passes through the outdoor condenser and the first expansion valve sequentially, and flows into the receiver dryer, a portion of the refrigerant in the receiver dryer flows to the second expansion valve, is expanded, exchanges heat with air in the evaporator, and circulates to the compressor, and another portion is expanded through the fourth expansion valve, flows to the chiller, exchanges heat with the cooling water in a cooling water line, and circulates to the compressor, and the flow rate of the refrigerant flowing into the indoor heat exchanger is controlled through the first and third expansion valves to achieve a target discharge temperature.

The heat pump system for a vehicle further includes: a receiver dryer configured to separate and store gaseous refrigerant and liquid refrigerant; a first expansion valve arranged between the receiver dryer and the outdoor condenser to expand the refrigerant; and a third direction switching valve arranged between the outdoor condenser and the receiver dryer, wherein the third direction switching valve is connected to the first expansion valve, an inlet of the receiver dryer, and an outlet of the receiver dryer, and the receiver dryer has one inlet and one outlet.

### Advantageous Effect

The heat pump system for a vehicle according to the present invention allows removal of an accumulator by optimizing the position of the receiver dryer and the control of the refrigerant flow, thereby reducing the number of components and lowering the manufacturing cost.

Moreover, the heat pump system for a vehicle according to the present invention can adjust the interior temperature of the vehicle even without a temperature door through the bypass structure of the indoor heat exchanger and the optimized arrangement of the expansion valves and prevent heat pickup to the indoor heat exchanger even when the temperature door is removed, thus reducing the number of components and downsizing the air conditioner.

Furthermore, the heat pump system for a vehicle according to the present invention can switch the refrigerant flow in the outdoor condenser according to the air conditioning mode through the simple structure, thus significantly improving air conditioning performance.

### DESCRIPTION OF DRAWINGS

FIG. 1 illustrates a conventional heat pump system for a vehicle.

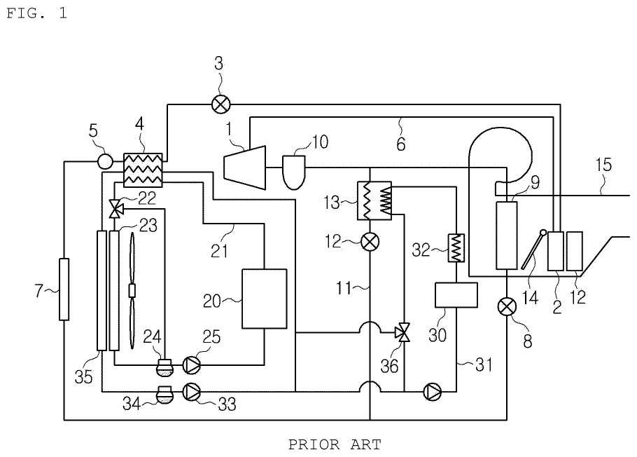

FIG. 2 illustrates a heat pump system for a vehicle according to a first embodiment of the present invention.

FIG. 3 illustrates a maximum heating mode of the heat pump system for a vehicle according to the first embodiment of the present invention.

FIG. 4 illustrates a heat absorption mode of an outdoor condenser during heating in the heat pump system for a vehicle according to the first embodiment of the present invention.

FIG. 5 illustrates a heat absorption mode of a chiller during heating in the heat pump system for a vehicle according to the first embodiment of the present invention.

FIG. 6 illustrates a dehumidification mode in the winter in the heat pump system for a vehicle according to the first embodiment of the present invention.

FIG. 7 illustrates a dehumidification and battery cooling mode in the winter in the heat pump system for a vehicle according to the first embodiment of the present invention.

FIG. 8 illustrates a dehumidification mode in the spring and autumn in the heat pump system for a vehicle according to the first embodiment of the present invention.

FIG. 9 illustrates a dehumidification and battery cooling mode in the spring and autumn in the heat pump system for a vehicle according to the first embodiment of the present invention.

FIG. 10 illustrates a maximum cooling mode in the heat pump system for a vehicle according to the first embodiment of the present invention.

FIG. 11 illustrates a temperature control mode during cooling in the heat pump system for a vehicle according to the first embodiment of the present invention.

FIG. 12 illustrates a cooling and battery cooling mode in the heat pump system for a vehicle according to the first embodiment of the present invention.

FIG. 13 illustrates a temperature control mode during cooling and battery cooling in the heat pump system for a vehicle according to the first embodiment of the present invention.

FIG. 14 illustrates a heat pump system for a vehicle according to a second embodiment of the present invention.

FIG. 15 illustrates a heating mode of the heat pump system for a vehicle according to the second embodiment of the present invention.

FIG. 16 illustrates a cooling mode of the heat pump system for a vehicle according to the second embodiment of the present invention.

### MODE FOR INVENTION

Hereinafter, a technical configuration of a heat pump system for a vehicle will be described in detail with reference to the accompanying drawings.

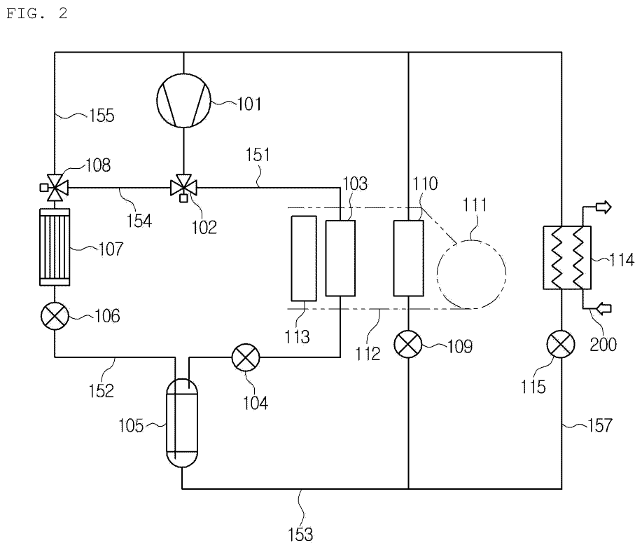

Referring to FIG. 2, a heat pump system for a vehicle according to a first embodiment of the present invention is installed in an electric vehicle or the like that does not use an engine, and performs cooling and heating of the interior of the vehicle using evaporation heat and condensation heat of a refrigerant. The heat pump system for a vehicle includes a refrigerant line and a cooling water line 200. The refrigerant line performs cooling or heating of the interior of the vehicle using refrigerant discharged from a compressor 101.

The refrigerant line includes a compressor 101, an indoor heat exchanger 103, an outdoor condenser 107, and a receiver dryer 105. The compressor 101 discharges refrigerant of high-temperature and high-pressure. The indoor heat exchanger 103 is provided in the t refrigerant line and arranged in an air conditioning case 112 to exchange heat between the refrigerant discharged from the compressor 101 and air. The indoor heat exchanger 103 heats the air using condensation heat.

In an air passage within the air conditioning case 112, an evaporator and the indoor heat exchanger 103 are sequentially provided. An electric heater 113 such as a PTC is provided downstream of the indoor heat exchanger 103 in an air flow direction. A blower module 111 is provided at an air inflow port of the air conditioning case 112 to blow inside air or outside air into the air conditioning case 112. In this case, there is no temperature door between the evaporator 110 and the indoor heat exchanger 103, and the air passing through the evaporator 110 directly passes through the indoor heat exchanger 103.

The outdoor condenser 107 is provided in the refrigerant line, and is arranged on the front side of the vehicle, namely, outside the air conditioning case 112, to condense the refrigerant by exchanging heat between the refrigerant and outdoor air. The receiver dryer 105 separates and stores gaseous refrigerant and liquid refrigerant. The evaporator 110 is provided downstream of the receiver dryer 105 in a refrigerant flow direction, and is arranged in the air conditioning case 112 to cool the air by exchanging heat between the refrigerant and air.

Specifically, the heat pump system for a vehicle according to the first embodiment of the present invention is configured such that a refrigerant inlet and a refrigerant outlet of the outdoor condenser 107 can be switched by switching the refrigerant flow direction of the refrigerant line.

That is, in a cooling mode, the refrigerant in the refrigerant line flows into the upper side of the outdoor condenser 107 and is discharged to the lower side in the direction of gravity. Moreover, in a heating mode, the refrigerant of the refrigerant line flows into the lower side of the outdoor condenser 107 and is discharged to the upper side in the direction of gravity. Through the configuration, in the heating mode, the refrigerant flows upward through the passage in the outdoor condenser 107, preventing liquid refrigerant from flowing into the compressor 101.

Additionally, the refrigerant discharged from the compressor 101 is selectively guided to the indoor heat exchanger 103 or the outdoor condenser 107. That is, the refrigerant discharged from the compressor 101 is configured to flow through or bypass the indoor heat exchanger 103. Through such a configuration, in a maximum cooling mode, the refrigerant can bypass the indoor heat exchanger 103, thereby preventing heat loss due to heat pickup caused by refrigerant heat in the indoor heat exchanger 103, even though there is no temperature door inside the air conditioning case 112.

Meanwhile, the refrigerant flow is controlled such that the receiver dryer 105 is located downstream of the outdoor condenser 107 in the refrigerant flow direction in the cooling mode and is located downstream of the indoor heat exchanger 103 in the heating mode. The receiver dryer 105 acts as an integrated refrigerant reservoir and can independently perform the refrigerant storage function even without an accumulator. In this case, overheating control of the refrigerant is performed by an electronic expansion valve (EXV), which will be described later.

That is, in the heating mode, the refrigerant flow is controlled such that the receiver dryer 105 is located downstream of the indoor heat exchanger 103. Therefore, refrigerant can be stored in the receiver dryer 105 not only in the cooling mode but also in the heating mode. As a result, the accumulator can be removed, reducing the number of components and lowering manufacturing costs.

In addition, the heat pump system for a vehicle according to an embodiment of the present invention includes a first direction switching valve 102, a second direction switching valve 108, a first expansion valve 106, a second expansion valve 109, and a third expansion valve 104 in the refrigerant line.

The first direction switching valve 102 is provided in the refrigerant line downstream of the compressor 101 in the refrigerant flow direction and selectively guides the refrigerant discharged from the compressor 101 to the indoor heat exchanger 103 or the outdoor condenser 107. The first direction switching valve 102 is configured as a three-way valve and is connected to the compressor 101, the indoor heat exchanger 103, and the second direction switching valve 108. That is, the refrigerant discharged from the compressor 101 flows to the indoor heat exchanger 103 via the first direction switching valve 102, to the outdoor condenser 107 via the second direction switching valve 108, or to both the indoor heat exchanger 103 and the outdoor condenser 107.

The second direction switching valve 108 guides the refrigerant passing through the first direction switching valve 102 to the outdoor condenser 107 or guides the refrigerant passing through the outdoor condenser 107 to the compressor 101. The second direction switching valve 108 is configured as a three-way valve and is connected to the first direction switching valve 102, the compressor 101, and the outdoor condenser 107.

That is, the second direction switching valve 108 performs only one of the two controls: guiding the refrigerant from the first direction switching valve 102 to the outdoor condenser 107, or guiding the refrigerant passing through the outdoor condenser 107 to the compressor 101.

The first expansion valve 106 is provided between the receiver dryer 105 and the outdoor condenser 107 to expand the refrigerant. The second expansion valve 109 is provided between the receiver dryer 105 and the evaporator 110 to expand the refrigerant. The third expansion valve 104 is provided between the indoor heat exchanger 103 and the receiver dryer 105 to expand the refrigerant.

In this case, the first expansion valve 106, the second expansion valve 109, and the third expansion valve 104 are all configured as electronic expansion valves (EXVs) that control the flow rate of the refrigerant and expand the refrigerant.

More specifically, the refrigerant line includes a first line 151, a second line 152, a third line 153, a fourth line 154, and a fifth line 155. The first line 151 is a refrigerant passage connecting the compressor 101 and the receiver dryer 105. The compressor 101, the first direction switching valve 102, the indoor heat exchanger 103, the third expansion valve 104, and the receiver dryer 105 are connected to the first line 151.

The second line 152 is a passage connecting the receiver dryer 105 and the second direction switching valve 108. The receiver dryer 105, the first expansion valve 106, the outdoor condenser 107, and the second direction switching valve 108 are connected to the second line 152. The third line 153 is a passage connecting the receiver dryer 105 and the compressor 101 via the evaporator 110. The receiver dryer 105, the second expansion valve 109, the evaporator 110, and the compressor 101 are connected to the third line 153.

The fourth line 154 is a passage connecting the first direction switching valve 102 and the second direction switching valve 108. The fifth line 155 is a passage connecting the second direction switching valve 108 and the compressor 101.

Moreover, the heat pump system for a vehicle according to the first embodiment of the present invention includes a bypass line 157, a fourth expansion valve 115, and a chiller 114. The bypass line 157 is provided downstream of the receiver dryer 105 in the refrigerant flow direction and is a passage through which the refrigerant bypasses the evaporator 110 and circulates to the compressor 101.

The fourth expansion valve 115 is provided in the bypass line 157 to expand the refrigerant. The fourth expansion valve 115 is configured as an electronic expansion valve (EXV) that controls the flow rate of the refrigerant and expands the refrigerant. The chiller 114 exchanges heat between the refrigerant and the cooling water of the cooling water line 200 circulating through an electrical component or a battery, thereby cooling the electrical component or the battery.

The cooling water line 200 may be configured to circulate through the electrical component including a power electric (PE) module, or the battery. That is, the cooling water line 200 may consist of an electrical component cooling water line and a battery cooling water line. The electrical component, an electrical radiator, and a water pump are provided in the electrical component cooling water line. The battery, a heating heater, a battery radiator, and a water pump are provided in the battery cooling water line.

The refrigerant that has passed through the receiver dryer 105 goes through the second expansion valve 109 through the third line 153, passes through the evaporator 110, and then, circulates to the compressor 101. Alternatively, the refrigerant bypasses the evaporator 110 through the bypass line 157, goes through the fourth expansion valve 115, passes through the chiller 114, and then, circulates to the compressor 101.

That is, among the gaseous refrigerant and the liquid refrigerant separated in the receiver dryer 105, the liquid refrigerant is discharged and flows toward the outdoor condenser 107 or the evaporator 110. Meanwhile, the receiver dryer 105 has three ports. A first port is connected to the indoor heat exchanger 103, a second port is connected to the evaporator 110, and a third port is connected to the outdoor condenser 107. The first port connected to the indoor heat exchanger 103 allows refrigerant to flow only into the receiver dryer 105. The second port connected to the evaporator 110 allows refrigerant to flow only out of the receiver dryer 105. The third port connected to the outdoor condenser 107 allows refrigerant to flow either into or out of the receiver dryer 105.

If the third port were configured like the second port such that the refrigerant only flows out of the receiver dryer, it would be advantageous to design a structure in which the third port branches downstream of the receiver dryer toward both the outdoor condenser and the evaporator. However, in the heat pump system of the present invention, in order to allow the refrigerant that has passed through the receiver dryer 105 to be expanded and evaporated in each air conditioning mode, one additional port is provided in the receiver dryer 105 so that the refrigerant flow between the outdoor condenser 107 and the receiver dryer 105 can be reversed in the cooling mode and the heating mode.

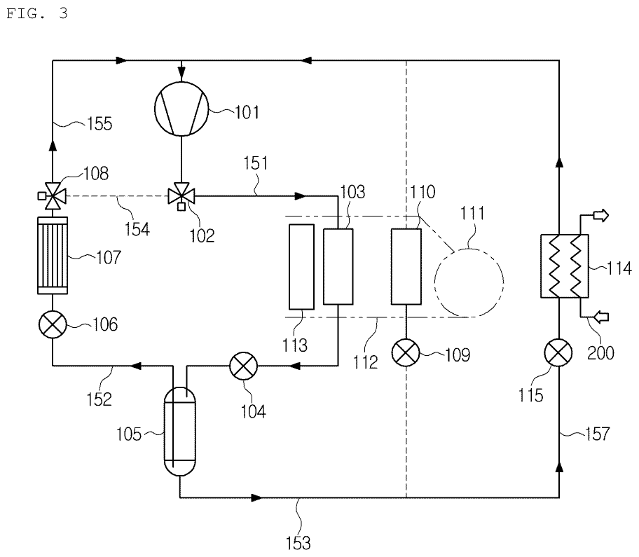

Referring to FIG. 3, in a maximum heating mode, the refrigerant discharged from the compressor 101 flows to the indoor heat exchanger 103 by the first direction switching valve 102, heats the air directed into the interior, passes through the third expansion valve 104, and then, flows into the receiver dryer 105. A portion of the refrigerant in the receiver dryer 105 is expanded by the first expansion valve 106, passes through the outdoor condenser 107, and then, circulates to the compressor 101 via the second direction switching valve 108. In this case, the refrigerant flows into the lower portion of the outdoor condenser 107 and moves upward to be discharged.

Another portion of the refrigerant from the receiver dryer 105 is expanded by the fourth expansion valve 115, passes through the chiller 114, and then, circulates to the compressor 101. As a result, the refrigerant absorbs outdoor heat in the outdoor condenser 107 and absorbs electrical component heat in the chiller 114.

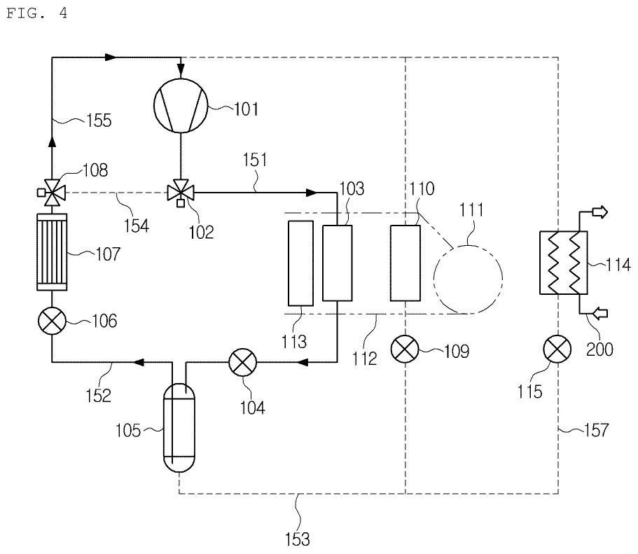

Referring also to FIG. 4, during heating, in the outdoor condenser heat absorption mode, the refrigerant discharged from the compressor 101 flows to the indoor heat exchanger 103 via the first direction switching valve 102, heats the air directed into the interior, and passes through the third expansion valve 104. Thereafter, the refrigerant passes through the receiver dryer 105, is expanded by the first expansion valve 106, passes through the outdoor condenser 107, and then, circulates to the compressor 101 via the second direction switching valve 108. In this case, the refrigerant enters the lower portion of the outdoor condenser 107 and moves upward to be discharged. Additionally, the refrigerant does not flow through the evaporator 110 or the chiller 114. Therefore, the refrigerant absorbs outdoor heat only in the outdoor condenser 107.

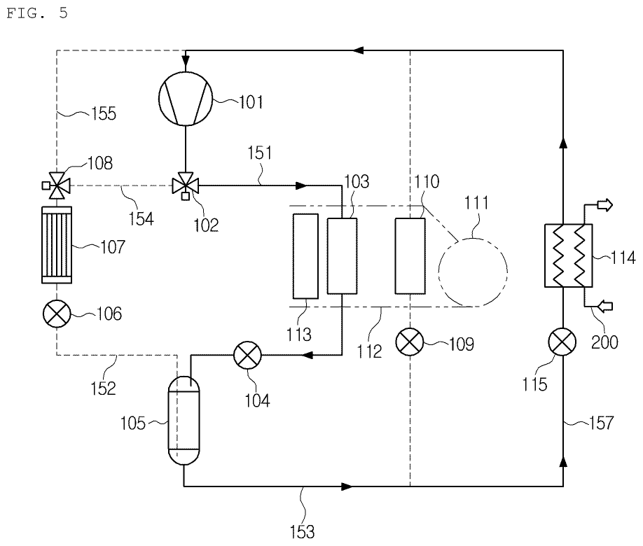

Referring to FIG. 5, during heating, in the chiller heat absorption mode, the refrigerant discharged from the compressor 101 flows to the indoor heat exchanger 103 via the first direction switching valve 102, heats the air directed into the interior, and passes through the third expansion valve 104.

Thereafter, the refrigerant passes through the receiver dryer 105 and flows into the bypass line 157. The refrigerant is expanded by the fourth expansion valve 115 and flows into the chiller 114 to exchange heat with the cooling water in the cooling water line 200. The refrigerant absorbs heat from the electrical component in the chiller 114 and circulates to the compressor 101.

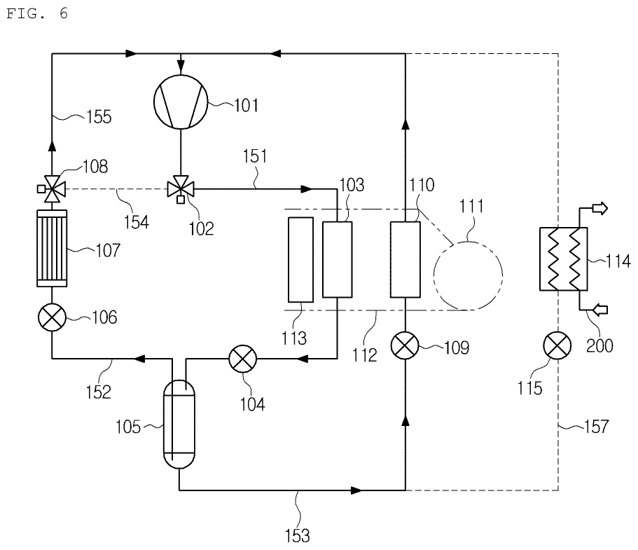

Referring to FIG. 6, in a dehumidification mode in the winter (under the condition that the temperature is below a reference level), the refrigerant discharged from the compressor 101 flows to the indoor heat exchanger 103 via the first direction switching valve 102, heats the air directed into the interior, passes through the third expansion valve 104, and then, flows into the receiver dryer 105. A portion of the refrigerant from the receiver dryer 105 is expanded by the first expansion valve 106, passes through the outdoor condenser 107, and then, circulates to the compressor 101 via the second direction switching valve 108. In this case, the refrigerant enters the lower portion of the outdoor condenser 107, and moves upward to be discharged.

Another portion of the refrigerant in the receiver dryer 105 is expanded by the second expansion valve 109, passes through the evaporator 110, and then, circulates to the compressor 101. The refrigerant in the evaporator 110 exchanges heat with air, thus performing dehumidification.

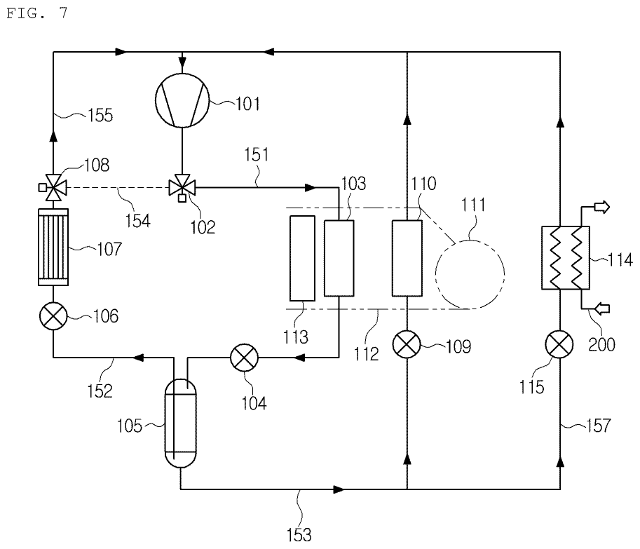

Referring to FIG. 7, in a dehumidification and battery cooling mode in the winter (under the condition that the temperature is below a reference level), the refrigerant discharged from the compressor 101 flows to the indoor heat exchanger 103 via the first direction switching valve 102, heats the air directed into the interior, passes through the third expansion valve 104, and then, flows into the receiver dryer 105. A portion of the refrigerant from the receiver dryer 105 is expanded by the first expansion valve 106, passes through the outdoor condenser 107, and then, circulates to the compressor 101 via the second direction switching valve 108. In this case, the refrigerant enters the lower portion of the outdoor condenser 107, and moves upward to be discharged.

Another portion of the refrigerant in the receiver dryer 105 flows to both the evaporator 110 and the chiller 114. That is, another portion of the refrigerant that has passed through the receiver dryer 105 is expanded by the second expansion valve 109, passes through the evaporator 110, and circulates to the compressor 101. The refrigerant in the evaporator 110 exchanges heat with air to perform dehumidification.

At the same time, another portion of the refrigerant that has passed through the receiver dryer 105 is expanded by the fourth expansion valve 115, flows into the chiller 114, and exchanges heat with the cooling water in the cooling water line 200. The refrigerant absorbs heat of the battery in the chiller 114 and circulates to the compressor 101. As a result, the battery is cooled in the chiller 114.

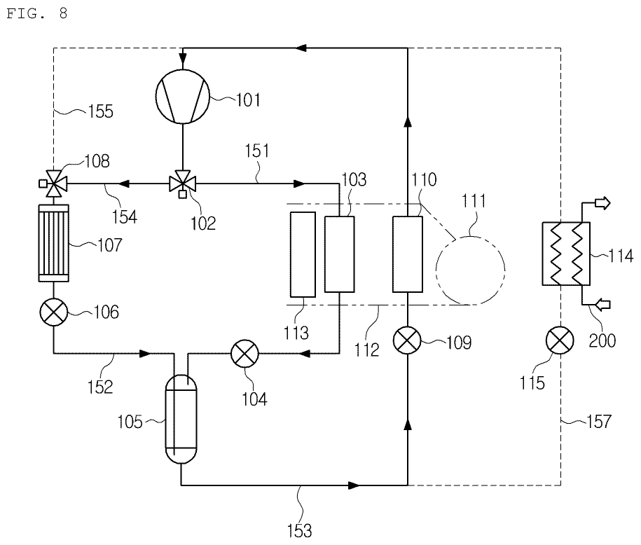

Referring to FIG. 8, in the dehumidification mode in the spring and autumn (under a condition that the temperature is above a reference level), a portion of the refrigerant discharged from the compressor 101 flows to the indoor heat exchanger 103 via the first direction switching valve 102, heats the air directed into the interior, passes through the third expansion valve 104, and then, flows into the receiver dryer 105.

Another portion of the refrigerant at the first direction switching valve 102 flows to the second direction switching valve 108, passes through the outdoor condenser 107, passes through the first expansion valve 106, and then, flows into the receiver dryer 105. In this case, the refrigerant enters the upper portion of the outdoor condenser 107 and moves downward to be discharged.

The refrigerant in the receiver dryer 105 flows to the second expansion valve 109, is expanded, exchanges heat with air in the evaporator 110, and then, circulates to the compressor 101. The refrigerant in the evaporator 110 exchanges heat with air to perform dehumidification.

As described above, the heat pump system for a vehicle according to the present invention can eliminate the conventional temperature door from the air conditioning case, and achieve the target discharge temperature by controlling the refrigerant flow rate to the indoor heat exchanger 103 using the first expansion valve 106 and the third expansion valve 104.

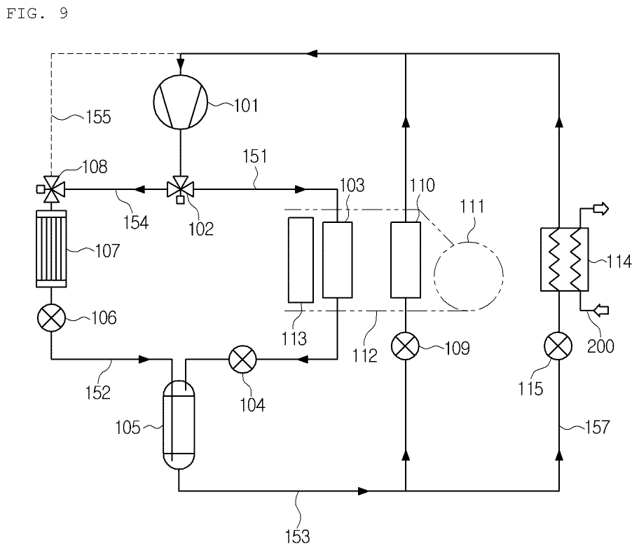

Referring to FIG. 9, in a dehumidification and battery cooling mode in the spring and autumn (under the condition that the temperature is above a reference level), a portion of the refrigerant discharged from the compressor 101 flows to the indoor heat exchanger 103 via the first direction switching valve 102, heats the air directed into the interior, passes through the third expansion valve 104, and then, flows into the receiver dryer 105.

Another portion of the refrigerant at the first direction switching valve 102 flows to the second direction switching valve 108, passes through the outdoor condenser 107, passes through the first expansion valve 106, and then, flows into the receiver dryer 105. In this case, the refrigerant enters the upper portion of the outdoor condenser 107 and moves downward to be discharged.

A portion of the refrigerant in the receiver dryer 105 flows to the second expansion valve 109, is expanded, exchanges heat with air in the evaporator 110, and then, circulates to the compressor 101. In the evaporator 110, the refrigerant exchanges heat with air, performing dehumidification.

Another portion of the refrigerant in the receiver dryer 105 is expanded by the fourth expansion valve 115, flows into the chiller 114, and exchanges heat with the cooling water in the cooling water line 200. The refrigerant absorbs heat of the battery in the chiller 114 and circulates to the compressor 101. As a result, the battery is cooled in the chiller 114.

As described above, the heat pump system for a vehicle according to the present invention can eliminate the conventional temperature door from the air conditioning case, and achieve the target discharge temperature by controlling the refrigerant flow rate to the indoor heat exchanger 103 using the first expansion valve 106 and the third expansion valve 104.

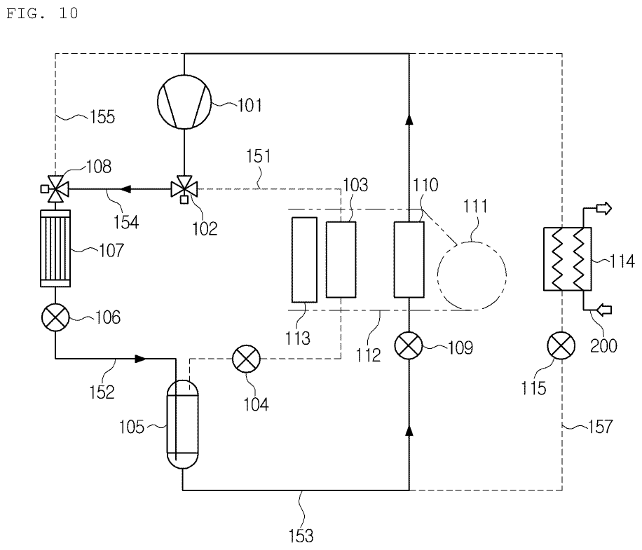

Referring to FIG. 10, in the maximum cooling mode, the refrigerant discharged from the compressor 101 flows to the second direction switching valve 108 via the first direction switching valve 102, passes through the outdoor condenser 107 and the first expansion valve 106 sequentially, and then flows into the receiver dryer 105. In this case, the refrigerant enters the upper portion of the outdoor condenser 107 and moves downward to be discharged.

The refrigerant that has passed through the receiver dryer 105 flows to the second expansion valve 109, is expanded, exchanges heat with air in the evaporator 110, and then, circulates to the compressor 101. The refrigerant in the evaporator 110 exchanges heat with air to cool the air.

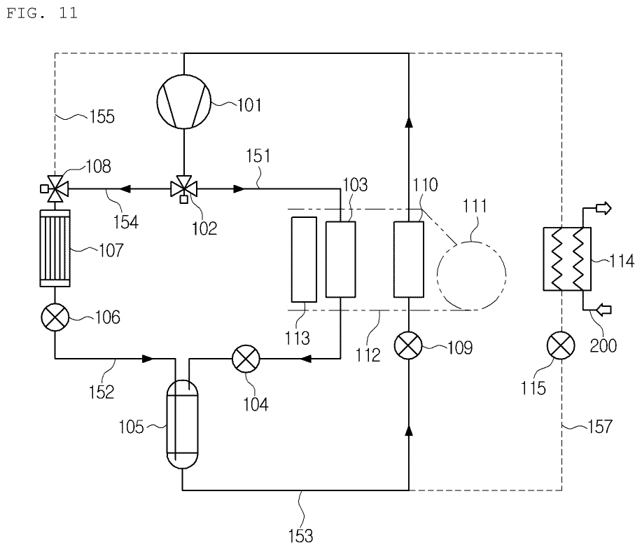

Referring to FIG. 11, during cooling, in a temperature control mode, a portion of the refrigerant discharged from the compressor 101 flows to the indoor heat exchanger 103 via the first direction switching valve 102, heats the air directed into the interior, passes through the third expansion valve 104, and then, flows into the receiver dryer 105.

Another portion of the refrigerant at the first direction switching valve 102 flows to the second direction switching valve 108, passes through the outdoor condenser 107 and the first expansion valve 106 sequentially, and then, flows into the receiver dryer 105. In this case, the refrigerant enters the upper portion of the outdoor condenser 107 and moves downward to be discharged.

The refrigerant that has passed through the receiver dryer 105 flows to the second expansion valve 109, is expanded, exchanges heat with air in the evaporator 110, and then, circulates to the compressor 101. The refrigerant in the evaporator 110 exchanges heat with air to cool the air. As a result, by controlling the amount of refrigerant flowing to the indoor heat exchanger 103, it is possible to control the temperature inside the vehicle.

That is, the heat pump system for a vehicle according to the present invention can eliminate the conventional temperature door from the air conditioning case, and achieve the target discharge temperature by controlling the refrigerant flow rate to the indoor heat exchanger 103 using the first expansion valve 106 and the third expansion valve 104.

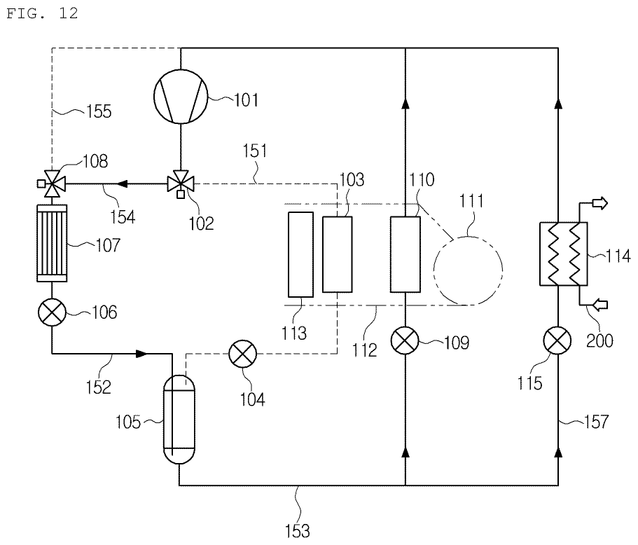

Referring to FIG. 12, in a cooling and battery cooling mode, the refrigerant discharged from the compressor 101 flows to the second direction switching valve 108 via the first direction switching valve 102, passes through the outdoor condenser 107 and the first expansion valve 106 sequentially, and then flows into the receiver dryer 105. In this case, the refrigerant enters the upper portion of the outdoor condenser 107 and moves downward to be discharged.

A portion of the refrigerant in the receiver dryer 105 flows to the second expansion valve 109, is expanded, exchanges heat with air in the evaporator 110, and then, circulates to the compressor 101. the refrigerant in the evaporator 110 exchanges heat with air, thereby performing cooling.

Another portion of the refrigerant in the receiver dryer 105 is expanded by the fourth expansion valve 115, flows into the chiller 114, and exchanges heat with the cooling water in the cooling water line 200. The refrigerant absorbs heat of the battery in the chiller 114 and circulates to the compressor 101. As a result, the battery is cooled in the chiller 114.

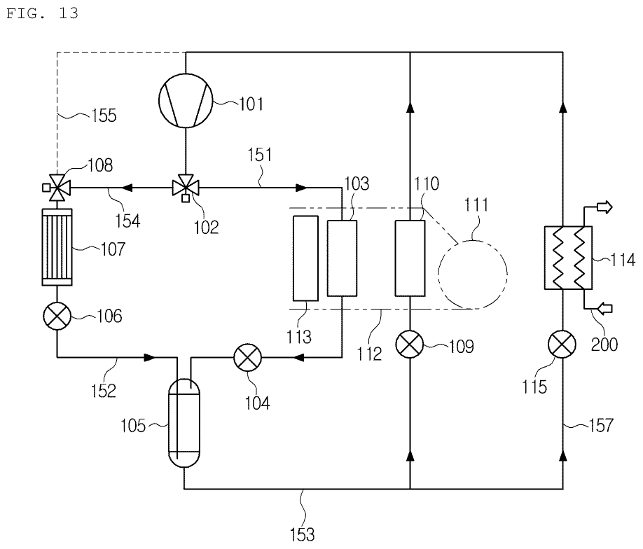

Referring to FIG. 13, during cooling and battery cooling, in the temperature control mode, a portion of the refrigerant discharged from the compressor 101 flows to the indoor heat exchanger 103 via the first direction switching valve 102, heats the air directed into the interior, passes through the third expansion valve 104 as is, and flows into the receiver dryer 105.

Another portion of the refrigerant at the first direction switching valve 102 flows to the second direction switching valve 108, passes through the outdoor condenser 107 and the first expansion valve 106 as is, and flows into the receiver dryer 105. In this case, the refrigerant enters the upper portion of the outdoor condenser 107 and moves downward to be discharged.

A portion of the refrigerant in the receiver dryer 105 flows to the second expansion valve 109, is expanded, exchanges heat with air in the evaporator 110, and then, circulates to the compressor 101. The refrigerant in the evaporator 110 exchanges heat with air, thereby performing cooling.

Another portion of the refrigerant r in the receiver dryer 105 is expanded by the fourth expansion valve 115, flows into the chiller 114, and exchanges heat with the cooling water in the cooling water line 200. The refrigerant absorbs heat of the battery in the chiller 114 and circulates to the compressor 101. As a result, the battery is cooled in the chiller 114.

That is, the heat pump system for a vehicle according to the present invention can eliminate the conventional temperature door from the air conditioning case, and achieve the target discharge temperature by controlling the refrigerant flow rate to the indoor heat exchanger 103 using the first expansion valve 106 and the third expansion valve 104.

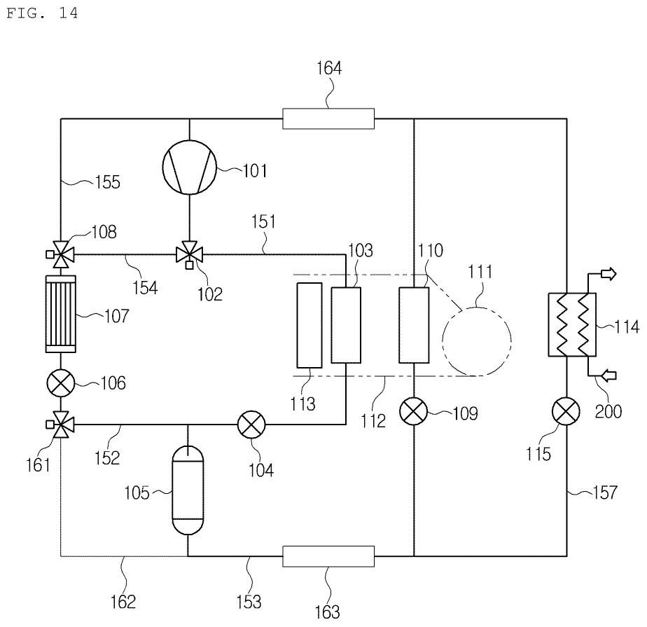

Referring to FIG. 14, a heat pump system for a vehicle according to a second embodiment of the present invention includes a refrigerant line and a cooling water line 200. The refrigerant line performs cooling or heating of the interior of the vehicle by using a refrigerant discharged from a compressor 101.

The refrigerant line includes the compressor 101, an indoor heat exchanger 103, an outdoor condenser 107, and a receiver dryer 105. In addition, the refrigerant line further includes a first direction switching valve 102, a second direction switching valve 108, a first expansion valve 106, a second expansion valve 109, a third expansion valve 104, and a fourth expansion valve 115.

In this embodiment, components identical to those of the first embodiment will not be described again, and only the differences will be explained. The heat pump system for a vehicle according to the second embodiment of the present invention further includes internal heat exchangers 163 and 164 for heat exchange of the refrigerant located upstream and downstream of the second expansion valve 109 and the fourth expansion valve 115 in the refrigerant flow direction.

Specifically, the heat pump system for a vehicle according to the second embodiment of the present invention further includes a third direction switching valve 161. The third direction switching valve 161 is connected to the first expansion valve 106, an inlet of the receiver dryer 105, and an outlet of the receiver dryer 105, respectively. In this case, the receiver dryer 105 has one inlet and one outlet. The third direction switching valve 161 and the outlet of the receiver dryer 105 are connected via a connection line 162.

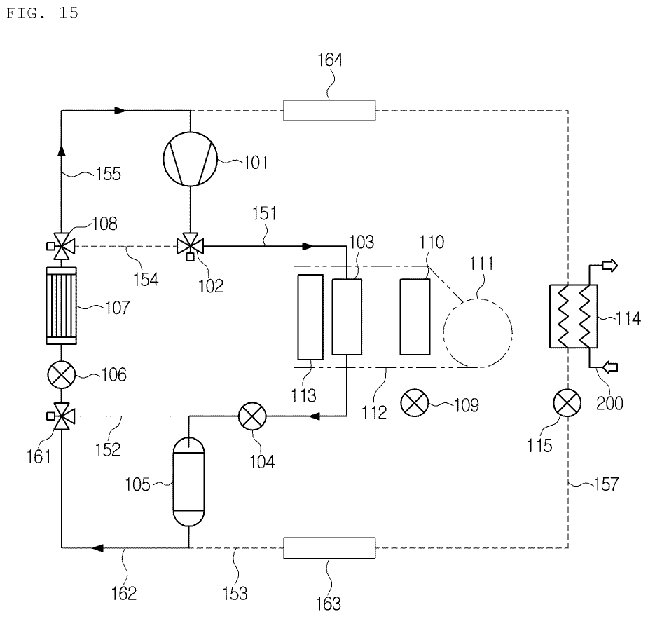

Referring to FIG. 15, in the heating mode, the refrigerant discharged from the compressor 101 flows to the indoor heat exchanger 103 via the first direction switching valve 102, heats the air directed into the interior, passes through the third expansion valve 104, and flows into the receiver dryer 105. The refrigerant entering the inlet of the receiver dryer 105 is discharged through the outlet, passes through the third direction switching valve 161 via the connection line 162, is expanded by the first expansion valve 106, passes through the outdoor condenser 107, and then, circulates to the compressor 101 via the second direction switching valve 108. In this case, the refrigerant enters the lower portion of the outdoor condenser 107 and moves upward to be discharged.

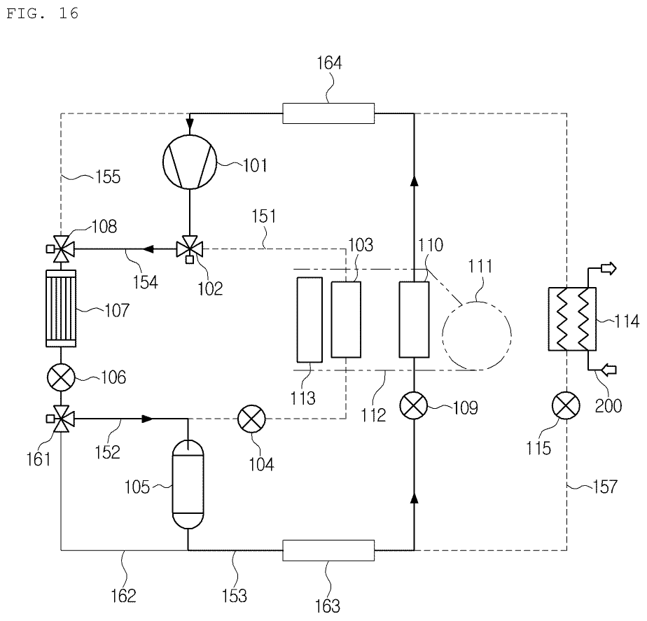

Referring to FIG. 16, in the cooling mode, the refrigerant discharged from the compressor 101 flows to the second direction switching valve 108 via the first direction switching valve 102, passes through the outdoor condenser 107 and the first expansion valve 106 sequentially, and then, flows into the receiver dryer 105. In this case, the refrigerant enters the upper portion of the outdoor condenser 107 and moves downward to be discharged.

The refrigerant entering the inlet of the receiver dryer 105 is discharged through the outlet, flows to the second expansion valve 109, is expanded, exchanges heat with air in the evaporator 110, and then, circulates to the compressor 101. The refrigerant in the evaporator 110 exchanges heat with air to cool the air.

While the heat pump system for the vehicle of the present invention has been described with reference to the illustrated embodiments, the descriptions are exemplary only, and it will be understood by those skilled in the art that various modifications and equivalents of the embodiments are possible. Therefore, the true technical protection scope should be defined by the technical spirit of the appended claims.

1. A heat pump system for a vehicle comprising a refrigerant line for cooling or heating an interior of the vehicle by using a refrigerant discharged from a compressor,
wherein the refrigerant line comprises an outdoor condenser configured to condense the refrigerant by exchanging heat between the refrigerant and outdoor air, and
wherein a refrigerant inlet and a refrigerant outlet of the outdoor condenser are switchable by switching a refrigerant flow direction of the refrigerant line.

2. The heat pump system for a vehicle according to claim 1, wherein, in a cooling mode, the refrigerant flows into an upper portion of the outdoor condenser and is discharged downward, and in a heating mode, the refrigerant flows into a lower portion of the outdoor condenser and is discharged upward.

3. The heat pump system for a vehicle according to claim 1, wherein the refrigerant line comprises an indoor heat exchanger arranged in an air conditioning case to exchange heat between the refrigerant discharged from the compressor and air, and
wherein the refrigerant discharged from the compressor Selectively flows to the indoor heat exchanger or the outdoor condenser.

4. The heat pump system for a vehicle according to claim 3, wherein the refrigerant discharged from the compressor is configured to pass through or bypass the indoor heat exchanger.

5. The heat pump system for a vehicle according to claim 3, further comprising:
a first direction switching valve arranged downstream of the compressor in the refrigerant flow direction and selectively directing the refrigerant discharged from the compressor to the indoor heat exchanger or the outdoor condenser; and
a second direction switching valve directing the refrigerant having passed through the first direction switching valve to the outdoor condenser or directing the refrigerant having passed through the outdoor condenser to the compressor.

6. The heat pump system for a vehicle according to claim 3, further comprising:
a receiver dryer configured to separate and store gaseous refrigerant and liquid refrigerant,
wherein the refrigerant flow is controlled such that in a cooling mode the receiver dryer is located downstream of the outdoor condenser in the refrigerant flow direction and in a heating mode the receiver dryer is located downstream of the indoor heat exchanger in the refrigerant flow direction.

7. The heat pump system for a vehicle according to claim 6, wherein the refrigerant line comprises:
an evaporator arranged downstream of the receiver dryer in the refrigerant flow direction and located in the air conditioning case to exchange heat between the refrigerant and air;
a first expansion valve arranged between the receiver dryer and the outdoor condenser to expand the refrigerant;
a second expansion valve arranged between the receiver dryer and the evaporator to expand the refrigerant; and
a third expansion valve arranged between the indoor heat exchanger and the receiver dryer to expand the refrigerant.

8. The heat pump system for a vehicle according to claim 7, further comprising:
a bypass line arranged downstream of the receiver dryer in the refrigerant flow direction and configured to circulate the refrigerant to the compressor by bypassing the evaporator;
a fourth expansion valve to expand the refrigerant and a chiller to exchange heat between the refrigerant and cooling water circulating through an electrical component or a battery are provided in the bypass line.

9. The heat pump system for a vehicle according to claim 8, wherein the first to fourth expansion valves are electronic expansion valves (EXVs) configured to control a flow rate of the refrigerant and expand the refrigerant.

10. The heat pump system for a vehicle according to claim 5, wherein the first direction switching valve is a three-way valve connected to the compressor, the indoor heat exchanger, and the second direction switching valve, and
wherein the second direction switching valve is a three-way valve connected to the first direction switching valve, the compressor, and the outdoor condenser.

11. A heat pump system for a vehicle comprising a refrigerant line for cooling or heating an interior of the vehicle by using a refrigerant discharged from a compressor,
wherein the refrigerant line comprises:
an outdoor condenser configured to condense the refrigerant by exchanging heat between the refrigerant and outdoor air; and
an indoor heat exchanger arranged in an air conditioning case to exchange heat between the refrigerant discharged from the compressor and air, and
wherein the refrigerant discharged from the compressor Selectively flows to the indoor heat exchanger or the outdoor condenser.

12. A heat pump system for a vehicle comprising a refrigerant line for cooling or heating an interior of the vehicle by using a refrigerant discharged from a compressor,
wherein the refrigerant line comprises:
an outdoor condenser configured to condense the refrigerant by exchanging heat between the refrigerant and outdoor air;
an indoor heat exchanger arranged in an air conditioning case to exchange heat between the refrigerant discharged from the compressor and air; and
a receiver dryer configured to separate and store gaseous refrigerant and liquid refrigerant,
wherein the refrigerant flow is controlled such that in a cooling mode the receiver dryer is located downstream of the outdoor condenser in the refrigerant flow direction and in a heating mode the receiver dryer is located downstream of the indoor heat exchanger in the refrigerant flow direction.

13. The heat pump system for a vehicle according to claim 12, wherein the refrigerant line includes an evaporator arranged downstream of the receiver dryer in the refrigerant flow direction and located in the air conditioning case to exchange heat between the refrigerant and air, and the liquid refrigerant among the gaseous refrigerant and the liquid refrigerant separated in the receiver dryer is discharged and flows toward the outdoor condenser or the evaporator.

14. The heat pump system for a vehicle according to claim 13, wherein the receiver dryer has three ports,
wherein a first port connected to the indoor heat exchanger allows refrigerant to flow only into the receiver dryer, and
wherein a second port connected to the evaporator allows refrigerant to flow only out of the receiver dryer.

15. The heat pump system for a vehicle according to claim 14, wherein a third port connected to the outdoor condenser allows refrigerant to flow into or out of the receiver dryer.

16. The heat pump system for a vehicle according to claim 8, wherein, in a dehumidification mode, a portion of the refrigerant discharged from the compressor flows to the indoor heat exchanger to heat air directed into the interior, passes through the third expansion valve, and flows into the receiver dryer, another portion of the refrigerant flows to the second direction switching valve, passes through the outdoor condenser and the first expansion valve sequentially, and flows into the receiver dryer, the refrigerant in the receiver dryer flows to the second expansion valve, is expanded, exchanges heat with air in the evaporator, and circulates to the compressor, and the flow rate of the refrigerant flowing into the indoor heat exchanger is controlled through the first and third expansion valves to achieve a target discharge temperature.

17. The heat pump system for a vehicle according to claim 8, wherein, in a dehumidification and battery cooling mode, a portion of the refrigerant discharged from the compressor flows to the indoor heat exchanger to heat air directed into the interior, passes through the third expansion valve, and flows into the receiver dryer, another portion of the refrigerant flows to the second direction switching valve, passes through the outdoor condenser and the first expansion valve sequentially, and flows into the receiver dryer, a portion of the refrigerant in the receiver dryer flows to the second expansion valve, is expanded, exchanges heat with air in the evaporator, and circulates to the compressor, and another portion is expanded through the fourth expansion valve, flows to the chiller, exchanges heat with the cooling water in a cooling water line, and circulates to the compressor, and the flow rate of the refrigerant flowing into the indoor heat exchanger is controlled through the first and third expansion valves to achieve a target discharge temperature.

18. The heat pump system for a vehicle according to claim 8, wherein, in a temperature control mode during cooling, a portion of the refrigerant discharged from the compressor flows to the indoor heat exchanger to heat air directed into the interior, passes through the third expansion valve, and flows into the receiver dryer, another portion of the refrigerant flows to the second direction switching valve, passes through the outdoor condenser and the first expansion valve sequentially, and flows into the receiver dryer, the refrigerant in the receiver dryer flows to the second expansion valve, is expanded, exchanges heat with air in the evaporator, and circulates to the compressor, and the flow rate of the refrigerant flowing into the indoor heat exchanger is controlled through the first and third expansion valves to achieve a target discharge temperature.

19. The heat pump system for a vehicle according to claim 8, wherein, in a temperature control mode during cooling and battery cooling, a portion of the refrigerant discharged from the compressor flows to the indoor heat exchanger to heat air directed into the interior, passes through the third expansion valve, and flows into the receiver dryer, another portion of the refrigerant flows to the second direction switching valve, passes through the outdoor condenser and the first expansion valve sequentially, and flows into the receiver dryer, a portion of the refrigerant in the receiver dryer flows to the second expansion valve, is expanded, exchanges heat with air in the evaporator, and circulates to the compressor, and another portion is expanded through the fourth expansion valve, flows to the chiller, exchanges heat with the cooling water in a cooling water line, and circulates to the compressor, and the flow rate of the refrigerant flowing into the indoor heat exchanger is controlled through the first and third expansion valves to achieve a target discharge temperature.

20. The heat pump system for a vehicle according to claim 5, further comprising:
a receiver dryer configured to separate and store gaseous refrigerant and liquid refrigerant;
a first expansion valve arranged between the receiver dryer and the outdoor condenser to expand the refrigerant; and
a third direction switching valve arranged between the outdoor condenser and the receiver dryer,
wherein the third direction switching valve is connected to the first expansion valve, an inlet of the receiver dryer, and an outlet of the receiver dryer, and
wherein the receiver dryer has one inlet and one outlet.
